(19) United States
(12) Patent Application Publication
(10) Pub. No.: US 2005/0053446 A1
(43) Pub. Date: Mar. 10, 2005

(54) Captive screw with receiving space

(76) Inventors: Chin-Fa Huang, Tu-chen (TW); Peng Yang, Shenzhen (CN); Qiong Ying Chen, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/925,289

(22) Filed: Aug. 23, 2004

(30) Foreign Application Priority Data
Sep. 5, 2003 (TW) 92216118

(51) Int. Cl. F16B 21/18

(52) U.S. Cl. 411/396

(57) ABSTRACT

A captive screw (80) is provided for attaching two sheets together. The captive screw includes a screw (40) and a cap (50). The screw includes a head (41), a threaded shank (43), and a flange (42) located between the head and the shank. The cap includes a cavity (51) and a skirt portion (53). The shank forms a plurality of ribs (52) on an underside thereof. The flange forms a plurality of vertical ridges (44) therearound. The cap and the screw are combined, with the head and the flange tightly fitted in the cavity. The shank extends out of the skirt portion, with cylindrical space defined therebetween. A rod portion of a complementary engaging rivet can then be received in the space.

### BACKGROUND OF THE INVENTION

1. Field of the Invention

The present invention relates to a screw having a threaded shank and being adapted to attach two sheets of material together, and particularly to a captive screw which can securely and firmly combine the sheets together.

2. Prior Art

Various conventional fasteners are utilized to attach two sheets of material together. The sheets may for example be the side plate or a bottom plate of an electronic device, and a printed circuit board (PCB). In another example, the sheets may be a pair of overlapping metal roof sheets or a pair of overlapping siding panels, which are normally fastened in place by conventional fasteners such as screws. Referring to FIG. 5, a first sheet 100 is to be securely attached to a second sheet 200. A rivet 300 is riveted in the second sheet 200. The rivet 300 defines a threaded axial through hole 310 in a rod portion 320 thereof, for engagingly receiving a conventional screw 900. The screw 900 comprises a threaded shank (not labeled) depending from a head (not labeled). The first and second sheets 100, 200 generally have standard thicknesses. Accordingly, a length of the threaded hole 310 of the rivet 300 is limited. When the screw 900 is fully engaged with the rivet 300, a region of engagement between the screw 900 and the rivet 300 is limited. This can result in a weak connection between the first and second sheets 100, 200. Referring also to FIG. 6, in order to improve the strength of the connection between the first and second sheets 100, 200, a rod portion 320′ of a rivet 300′ is lengthened and extends out from the first sheet 100. However, when the screw 900 is fully threaded into a threaded hole 310′ of the rivet 300′, an underside of the head of the screw 900 cannot contact a top surface of the first sheet 100. This can result in a weak connection between the first and second sheets 100, 200.

Thus, an improved captive screw which solves the above-mentioned problems is strongly desired.

### SUMMARY OF THE INVENTION

Accordingly, an object of the present invention is to provide a screw with a cap which securely and firmly combines two sheets together.

To achieve the above-mentioned object, a captive screw in accordance with the present invention is provided for attaching two sheets together. The captive screw includes a screw and a cap. The screw includes a head, a threaded shank, and a flange located between the head and the shank. The cap includes a cavity and a skirt portion. The shank forms a plurality of ribs on an underside thereof. The flange forms a plurality of vertical ridges therearound. The cap and the screw are combined, with the head and the flange tightly fitted in the cavity. The shank extends out of the skirt portion, with a cylindrical space defined therebetween. A rod portion of a complementary engaging rivet can then be received in the space.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is an exploded, isometric view of a captive screw of the present invention;

FIG. 2 is an assembed view of the captive screw of FIG. 1, but showing the captive screw inverted;

FIG. 3 is a schematic, cross-sectional view taken along line III-III of FIG. 2;

FIG. 4 is a schematic, cross-sectional view, showing the captive screw of FIG. 3 cooperating with a rivet to attach a pair of sheets together;

FIG. 5 is a schematic, cross-sectional view of a conventional screw cooperating with a first rivet to attach two sheets together; and

FIG. 6 is similar to FIG. 5, but showing the conventional screw cooperating with a second rivet to attach the two sheets together.

### DESCRIPTION OF THE PREFERRED EMBODIMENT

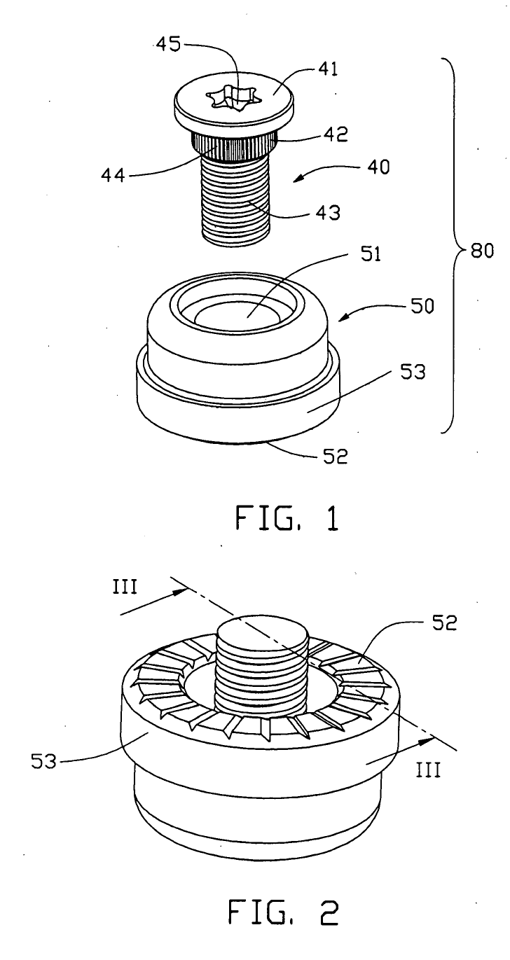

Referring to FIGS. 1 and 4, a captive screw 80 of the present invention is utilized to attach a first sheet 10 and a second sheet 20 together. The captive screw 80 comprises a screw 40 and a cap 50.

The screw 40 comprises a head 41, a threaded shank 43, and a flange 42 connecting between the head 41 and the shank 43. The flange 42 is generally cylindrical. A diameter of the flange 42 is greater than that of the shank 43. A plurality of closely spaced, vertical slim ridges 44 is formed around an outer circumferential surface of the flange 42. A topmost portion of the head 41 defines a generally hexagonal recess 45 therein, which is adapted to engagingly receive a driving tool (not shown).

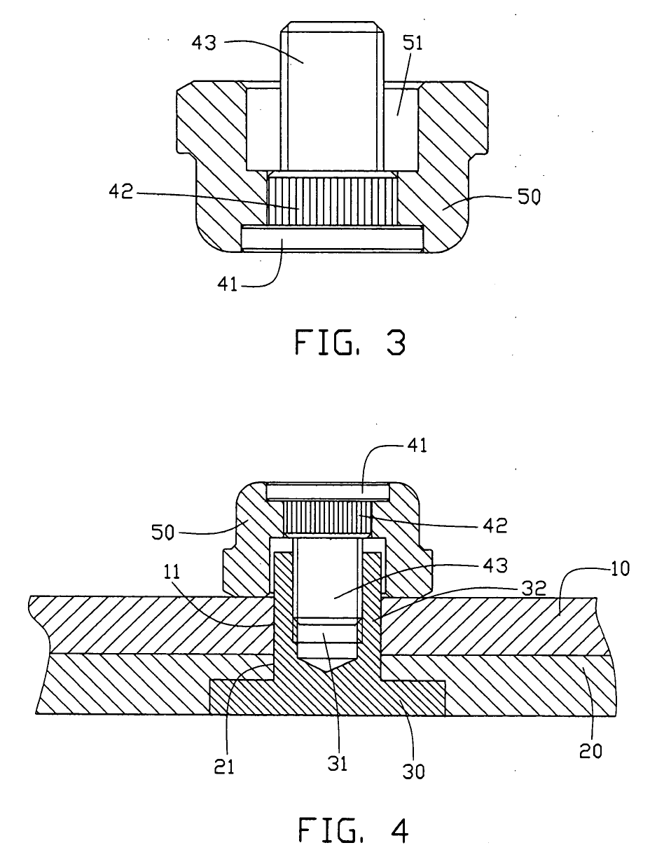

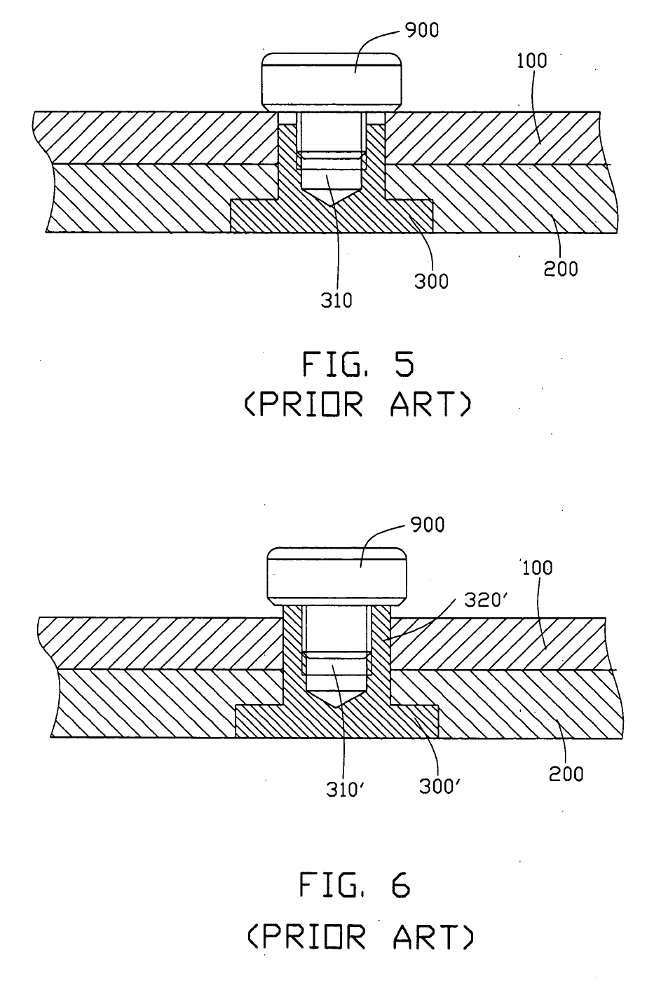

Referring also to FIGS. 2 and 3, the cap 50 defines a generally cylindrical cavity 51 therein. An enlarged annular skirt portion 53 is formed on a lower portion of the cap 50. A plurality of radial ribs 52 is formed on an underside of the skirt portion 53. The cavity 51 closely conforms to a size and shape of the head 41 and the flange 42 of the screw 40. The head 41 and flange 42 are fitted within the cavity 51, with the ridges 44 tightly abutting an inner circumferential surface of cap 50. The shank 43 protrudes slightly out from the skirt portion 53, with a cylindrical space being defined between the shank 43 and the skirt portion 53. The cap 50 and screw 40 thus form a combined unit.

The first sheet 10 defines through hole 11 therein. The second sheet 20 defines a slot 21 therein corresponding to the through hole 11. A rivet 30 is riveted in the slot 21. The rivet 30 comprises a rod portion 32 defining a threaded hole 31 therein. In use of the captive screw 80, the first sheet 10 is placed on the second sheet 20, with the rod portion 32 protruding out from the through hole 11 of the first sheet 10. Then, the captive screw 80 is engaged with the free end of the rivet 30. The threaded shank 43 is fitted in the through hole 31 of the rivet 30, with the free end of the rod portion 32 of the rivet 30 being received in said cylindrical space of the cap 50. When the captive screw 80 is fully threaded onto the rivet 30, the ribs 52 of the skirt portion 53 interferentially engage against a top surface of the first sheet 10 (as shown in FIG. 4). The first and second sheets 10, 20 are thus attached together by the rivet 30 and the captive screw 80.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to full extent indicated by the broad general meaning of the terms in which the appended claims are expressed.

1. A captive screw adapted for attaching two sheets together, comprising:
a screw comprising a head, an elongated and axially extending threaded shank, the threaded shank adapted to engage with a rivet which extends into the sheets; and
a cap comprising a cavity receiving the screw, and an annular skirt portion;
wherein when the screw is combined with the cap, the shank protrudes out from the skirt portion with a space defined therebetween, the space adapted to receive an end portion of the rivet.

2. The captive screw as described in claim 1, wherein the head of the screw defines a recess.

3. The captive screw as described in claim 1, wherein a flange is located between the head and the shank of the screw, the flange forms a plurality of ridges therearound, and the ridges tightly abuts an inner circumferential surface of the cap.

4. The captive screw as described in claim 1, wherein the skirt portion forms a plurality of generally radial ribs on an underside thereof.

5. The captive screw as described in claim 1, wherein a diameter of the flange is greater than that of the shank.

6. A captive screw assembly comprising:
a first sheet defining a through hole therein;
a second sheet defining a slot therein;
a rivet riveted in the slot of the second sheet, the rivet comprising a rod portion, the rod portion extending through the through hole of the first sheet and defining a threaded hole therein;
a captive screw engaging in the threaded hole of the rivet and attaching the first sheet and the second sheet together, the captive screw comprising a screw and a cap, the screw comprising a head, and a threaded shank extending from the head and engaging in the threaded hole of the rivet, the cap comprising a skirt portion defining a cavity therein, the head being held in the cavity, the skirt portion and shank cooperatively defining a space therebetween;
wherein when the first sheet is placed on the second sheet with the rod portion of the rivet extending through the through hole, the shank of the screw is engagingly fitted in the threaded hole of the rivet in order to combine the sheets together, the rod portion extends into said space, and the skirt portion engages against the first sheet.

7. The captive screw assembly as described in claim 6, wherein a flange is located between the head and the shank of the screw, the flange forms a plurality of ridges therearound, and the ridges tightly abuts an inner circumferential surface of the cap.

8. The captive screw assembly as described in claim 6, wherein the skirt portion forms a plurality of generally radial ribs on an underside thereof.

9. A captive screw assembly comprising:
a first sheet defining a first through hole therein;
a second sheet located under said first sheet and defining a second through hole in vertical alignment with the first through hole therein;
a screw nut defining a cylindrical section upwardly extending through both said second through hole and said first through hole with a tip section extending above the first sheet, said cylindrical section defining internal threads, the screw nut providing a stopper for preventing downward movement of the second sheet relative to the screw nut;
a captive screw unit downwardly extending into the first through hole and including a screw portion with external threads engaged with the internal threads of the cylindrical section, and a cap portion downwardly urged by the screw portion and dimensioned long enough to have a bottom face contacting and downwardly pressing the first sheet tightly against the second sheet; wherein
the tip section of the cylindrical section is essentially located radially between the screw portion and the cap portion.

10. The captive screw assembly as claimed in claim 9, wherein said screw nut is of a sunk-head type.

11. The captive screw assembly as claimed in claim 10, wherein said second through hole defines a sunk portion.

12. A captive screw assembly comprising:
a first sheet defining a first through hole therein;
a second sheet located under said first sheet and defining a second through hole in vertical alignment with the first through hole therein;
a first screw piece defining a first cylindrical section extending in a first direction through both said second through hole and said first through hole with a tip section extending above the first sheet, said first cylindrical section defining first threads, the first screw piece providing a stopper for preventing downward movement of the second sheet relative to the screw nut; and
a second screw piece extending into the first through hole in a second direction opposite to the first direction, and including a second cylindrical section with second threads engaged with the first threads of the first cylindrical section, and
a cap portion downwardly urged by the second cylindrical section and dimensioned long enough to have a bottom face contacting and downwardly pressing the first sheet tightly against the second sheet; wherein
interengagement between the first threads and the second threads occurs not only in at least one of the first and the second through holes, but also above the first sheet.

13. The captive screw assembly as claimed in claim 12, wherein said second cylindrical section and said cap portion are discrete from each other.

14. The captive screw assembly as claimed in claim 12, wherein said first screw piece is a screw nut and the first threads are internal threads.

15. The captive screw assembly as claimed in claim 12, wherein said second through hole defines a sunk portion so as to allow a head of the first screw piece to be hidden therein.
